(19) United States
(12) Patent Application Publication
(10) Pub. No.: US 2003/0107865 A1
(43) Pub. Date: Jun. 12, 2003

(54) Wafer handling apparatus and method of manufacturing the same

(76) Inventors: Shinsuke Masuda, Himeji-Shi (JP); Kiyotoshi Fujii, Himeji-Shi (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/198,052

(22) Filed: Jul. 19, 2002

Related U.S. Application Data
(63) Continuation-in-part of application No. 10/006,657, filed on Dec. 10, 2001.

(30) Foreign Application Priority Data
Dec. 11, 2000 (JP) JP 2000-376599
May 1, 2001 (JP) JP 2001-134121
May 1, 2001 (JP) JP 2001-134122

(51) Int. Cl. H02N 13/00

(52) U.S. Cl. 361/234

(57) ABSTRACT

Disclosed is a wafer handling device having a coating layer (3) surrounding a wafer handling device (1,2) that consists essentially of non-crystalline carbon (DLC) having electric resistivity ranging from 10 sup 8 to 10 sup 13/ &-cm. The coating layer preferably contains 15-26 atom % of hydrogen. The coating layer preferably has an intensity ratio of 0.7-1.2, the intensity ratio being defined as a ratio of an intensity at 1360 cm⁻¹ to another intensity at 1500 cm⁻¹ when said coating layer is subjected to Raman spectroscopic analysis. The coating layer is manufactured by the P-CVD process wherein hydrocarbon (CxHy) is introduced into a vacuum container and ionized therein by ionizing process and ionized hydrocarbon is deposited on the surface of said wafer handling device by applying thereto a predetermined pulse voltage within an after-glow time of smaller than 250 microseconds.

### BACKGROUND OF THE INVENTION

### CROSS-REFERENCE TO RELATED APPLICATIONS

This application is a continuation-in-part of Application Serial No. 10/006,657, filed Dec. 10, 2001, the disclosure of which is incorporated by reference.

1. Field of the Invention

The present invention relates to a wafer handling device particularly for use as a support and transfer device in a processing or manufacturing process of semiconductor wafer, flat panel display (FPD) and other materials (glass, aluminum, high polymer substances, etc.) for various electronic devices.

2. Description of the Related Art

Wafer handling devices, such as heaters, an electrostatic chucks, transfer paddles, cassettes, susceptors, and wafer trays may be used to support and transfer a silicon wafer or other workpiece during processing of the workpiece and during transport between filming processes such as chemical vapor deposition (CVD), physical vapor deposition (PVD), dry etching, etc. A typical example of the wafer handling device is shown in FIG. 1, which may comprise a handling device body of graphite substrate 1 surrounded by an insulator 2 of pyrolytic boron nitride (PBN) or other insulating material. The wafer handling device may further include electrodes 3 of pyrolytic graphite (PG) or other conductive material superimposed upon or imbedded within the handling device body in a predetermined pattern, and an insulating separator or coating layer 4 surrounding the handling device body for separating the conductive electrodes 3 from the workpiece. Another construction of the wafer handling device may comprise a ceramic substrate such as oxides and nitrides, conductive electrodes of molybdenum (Mo), Tantalum (Ta), tungsten (W) or any other metal having a high-melting point, and DLC (Diamond like carbon) coating layer surrounding the handling device body. Although not shown in FIG. 1, opposite ends of any electrodes 3 may be respectively connected to terminals, which in turn are connected to a power source.

A source of voltage may be applied across the electrodes to generate a Coulomb force when a silicon wafer or other workpiece 5 is placed on an upper surface of the handling device of FIG. 1. The workpiece 5 is electrostatically attracted or clamped to the handling surface. In this arrangement, the wafer handling device also serves as a heater for uniformly heating the workpiece 5 to a temperature at which an optimum filming operation should be expected.

The wafer handling device of FIG. 1 may be of a bipolar type. If it is modified to a monopolar handling device, a single electrode may be superimposed upon or imbedded within the handling device body and a chucking voltage may be applied between the single electrode and the workpiece on the handling surface.

Coating 4 of the wafer handling device may have an electrical resistivity of between 10 sup 8 and 10 sup 13/&−cm (10⁸˜10¹³/&−cm). The coating 4 having such a range of the electrical resistivity allows a feeble current to pass through the over coating 4 and the workpiece 5, which greatly increases the chucking force as known in the art as the AJohnsen-Rahbek@ effect. U.S. Pat. No. 5,606,484 issued May 5, 1998 to Honma et al., the disclosure of which is herein incorporated by reference, teaches that the coating is composed of a composition containing PBN and a carbon dopant in an amount above 0 wt. % and less than 3 wt. %, which assures that the separator has the above-described range of the electric resistivity. The carbon doping may be effected by a chemical vapor deposition (CVD). A carbon-doped PBN coating 4 may be formed by introducing a low pressure, thermal CVD furnace a hydrocarbon gas such as methane (carbon source), for example, as well as a reaction gas such as a mixture of boron trichloride and ammonia (BN source), for example, for codeposition of the over coating 4, so that some amount of carbon is doped into the over coating 4.

The coating 4 of the wafer handling device may be required to have not only the above- described range of electric resistivity but also other important characteristics including surface smoothness, thin-film formabilityandwear-resistance. When the handling device should also serve as heater as shown FIG. 1, it should satisfy additional requirements for thermal conductivity, infrared permeability, etc.

Although the wafer handling device taught by the above-referenced U.S. Patent satisfies most of these requirements, the carbon-doped PBN (C-PBN) constituting the coating has a crystal structure which would tend to be separated from the handling device body resulting in a degraded durability. During use, the crystalline C-PBN may produce particles. It is necessary to control the chemical reaction of plural gases (for example, boron trichloride and ammonia for producing a PBN compact, and methane for doping carbon into the PBN compact), but such control is very delicate, which makes it difficult to provide a definite range of the electric resistivity to the coating of the final products. The prior art technique has another problem that the coating thickness tends to be non-uniform, which requires surface grinding as a finishing process.

### SUMMARY OF THE INVENTION

After thorough study and repeated experiments and tests, the inventors have found that a non-crystalline carbon, referred to as diamond-like carbon (DLC), is most preferable material of the coating of the wafer handling device, because DLC satisfies substantially all of the above-described requirements.

More particularly, DLC has been known as a kind of carbon isotope, having a mixture of a graphite structure (SP2) and a diamond structure (SP3). Accordingly, it is easy to control its electric resistivity within a range of between 10 sup 8 and 10 sup 13/&−cm (10⁸˜10¹³/&−cm), which is higher than the electric resistivity of a conductive graphite of the order of between 10 sup −3 and lower than that of diamond, that is a well known insulating material, of between 10 sup 12 and 10 sup 16_@/&−cm(10¹²˜10¹⁶/&−cm). DLC is a preferable material to use as a protective coating for the surface of a handling device, because of its inherent material properties such as high hardness, surface smoothness, low coefficient of friction, wear-resistance and thin film formability. In addition, DLC is a preferable material for thermal applications, because its superb thermal conductivity and infrared permeability.

DLC has been used as a surface hardening material for various machine parts and tools such as cutting tools, molds, etc. It has also been used as components in a processing or manufacturing process of hard discs, magnetic tapes for VTR (video tape recording ) systems and some other electronic devices. As far as the inventors have been aware of, no prior art teaches applicability of DLC to the coating material of the wafer handling device.

Accordingly, it is the prime objective of the present invention to overcome the drawbacks and disadvantages of the prior art wafer handling device and provides a novel construction of the wafer handling device particularly suitable for use as a clamping device in semiconductor wafer processes such as PVD, CVD, etc. and in manufacturing processes of flat panel displays including liquid crystal.

To achieve this and other objectives, according to an aspects of the present invention, there is provided a wafer handling device (hereinafter called WHD) comprising a protective coating layer surrounding the wafer handling device, wherein the surface protective coating layer may consist essentially of non-crystalline carbon with electric resistivity ranging from 10 sup 8 and 10 sup 13/&−cm. Preferably, the coating layer has thickness of at least 2.5 micrometers. The coating layer may be formed by a plasma chemical vapor deposition (P-CVD) process. The coating layer may contain 15-26 atom % of hydrogen.

According to another aspect of the present invention, there may be provided a WHD for transferring and supporting a workpiece comprising a wafer handling device, a coating layer surrounding the wafer handling device, and a surface protection layer formed on at least one surface of the coating layer and consisting essentially of non-crystalline carbon having electric resistivity ranging from 10 sup 8 and 10 sup 13/&−cm. The surface protection layer preferably contains 15-26 atom % of hydrogen.

According to still another aspects of the present invention, there may be provided a WHD for supporting and transferring a workpiece comprising a wafer handling device, a coating layer surrounding the wafer handling device, the coating layer consisting essentially of non-crystalline carbon and having electric resistivity ranging from 10 sup 8 and 10 sup 13/&−cm, the coating layer having an intensity ratio of 0.7-1.2, said intensity ratio being defined as a ratio of an intensity at 1360 cm⁻to another intensity at 1500 cm⁻¹ when said coating layer may be subjected to Raman spectroscopic analysis. Preferably, the coating layer has thickness of at least 2.5 micrometers. The coating layer may be preferably formed by a plasma chemical vapor deposition (P-CVD) process. The coating layer preferably contains 15-26 atom % of hydrogen.

According to still another aspect of the present invention, there may be provided a WHD for supporting and transferring a workpiece comprising a wafer handling device, a coating layer surrounding said wafer handling device, a surface protection layer formed on at least one surface of said coating layer and consisting essentially of non-crystalline carbon and having electric resistivity ranging from 10 sup 8 and 10 sup 13/&−cm, said surface protection layer having an intensity ratio of 0.7-1.2, said intensity ratio being defined as a ratio of an intensity at 1360⁻¹ cm to another intensity at 1500⁻¹ when said surface protection coating layer may be subjected to Raman spectroscopic analysis. The surface protection layer preferably contains 15-26 atom % of hydrogen.

There is also provided a method of manufacturing a WHD comprising the steps of subjecting a wafer handling device to a plasma chemical vapor deposition process wherein hydrocarbon (CxHy) of which (x) ranges 1-10 and (y) ranges 2-22 may be introduced into a vacuum container and ionized therein by ionizing (plasma) process and ionized hydrocarbon may be deposited on the surface of said wafer handling device by applying thereto a predetermined pulse voltage, so that said wafer handling device is coated with a coating layer consisting essentially of non-crystalline carbon and having electric resistivity ranging from 10 sup 8 and 10 sup 13/&−cm.

Another method of manufacturing a WHD is also provided which may include the steps of subjecting a wafer handling device to a plasma chemical vapor deposition process wherein hydrocarbon (CxHy) may be introduced into a vacuum container and ionized therein by an ionizing (plasma) process and ionized hydrocarbon may be deposited on the surface of said wafer handling device by applying thereto a pulse voltage ranging from −1 kV to −20 kV, so that said wafer handling device is coated with a coating layer consisting essentially of non-crystalline carbon and having electric resistivity ranging from 10 sup 8 and 10 sup 13/&−cm.

Still another method of manufacturing a WHD is also provided which may include the steps of subjecting a wafer handling device to a plasma chemical vapor deposition process wherein hydrocarbon (CxHy) may be introduced into a vacuum container and ionized therein by an ionizing (plasma) process and ionized hydrocarbon may be deposited on the surface of said wafer handling device by applying thereto a predetermined pulse voltage within an after-glow time of smaller than 250 microseconds, so that said wafer handling device is coated with a coating layer consisting essentially of non-crystalline carbon and having electric resistivity ranging from 10 sup 8 and 10 sup 13/&−cm.

Still another method of manufacturing a WHD is also provided which may include the steps of subjecting a wafer handling device to a plasma chemical vapor deposition process wherein hydrocarbon (CxHy) of which (x) ranges 1-10 and (y) ranges 2-22 may be introduced into a vacuum container and ionized therein by an ionizing (plasma) process and ionized hydrocarbon may be deposited on the surface of said wafer handling device by applying thereto a pulse voltage ranging from −1 kV to −20 kV within an after-glow time of smaller than 250 microseconds, so that said wafer handling device is coated with a coating layer consisting essentially of non-crystalline carbon and having electric resistivity ranging from 10 sup 8 and 10 sup 13/&−cm.

Still another method of manufacturing a WHD is also provided which may include the steps of coating a wafer handling device with an insulating coating layer; and subjecting a resulting product to a plasma chemical vapor deposition process wherein hydrocarbon (CxHy) of which (x) ranges 1-10 and (y) ranges 2-22 may be introduced into a vacuum container and ionized therein by an ionizing (plasma) process and ionized hydrocarbon may be deposited on the surface of said coating layer by applying thereto a predetermined pulse voltage, so that said coating layer may be coated with a surface protection layer consisting essentially of non-crystalline carbon and having electric resistivity ranging from 10 sup 8 and 10 sup 13/&−cm.

Still another method of manufacturing a WHD is also provided which may include the steps of coating a wafer handling device with a coating layer; and subjecting a resulting product to a plasma chemical vapor deposition process wherein hydrocarbon (CxHy) may be introduced into a vacuum container and ionized therein by an ionizing (plasma) process and ionized hydrocarbon may be deposited on the surface of said wafer handling device by applying thereto a pulse voltage ranging from −1 kV to −20 kV, so that said coating layer may be coated with a surface protection layer consisting essentially of non-crystalline carbon and having electric resistivity ranging from 10 sup 8 and 10 sup 13/&−cm.

Still another method of manufacturing a WHD is also provided which may include the steps of coating a wafer handling device with a coating layer; and subjecting a resulting product to a plasma chemical vapor deposition process wherein hydrocarbon (CxHy) may be introduced into a vacuum container and ionized therein by an ionizing process and ionized hydrocarbon may be deposited on the surface of said coating layer by applying thereto a predetermined pulse voltage within an after-glow time of smaller than 250 microseconds, so that said coating layer may be coated with a surface protection layer consisting essentially of non-crystalline carbon and having electric resistivity ranging from 10 sup 8 and 10 sup 13/&−cm.

Still another method of manufacturing a WHD is also provided which may include the steps of coating a wafer handling device with a coating layer; and subjecting a resulting product to a plasma chemical vapor deposition process wherein hydrocarbon (CxHy) of which (x) ranges 1-10 and (y) ranges 2-22 may be introduced into a vacuum container and ionized therein by an ionizing (plasma) process and ionized hydrocarbon may be deposited on the surface of said coating layer by applying thereto a pulse voltage ranging from −1 kV to −20 kV within an after-glow time of smaller than 250 microseconds, so that said coating layer may be coated with a surface protection layer consisting essentially of non-crystalline carbon and having electric resistivity ranging from 10 sup 8 and 10 sup 13/&−cm.

### BRIEF DESCRIPTION OF THE DRAWINGS

Other objectives and advantages of the present invention can be understood from the following description when read in conjunction with the accompanying drawing in which:

FIG. 1 is a diagrammatic cross-sectional view showing a WHD to which the present invention is applicable;

FIG. 2. is a diagrammatic cross-sectional view showing another construction of the WHD to which the present invention is also applicable;

FIG. 3. is a chart showing the result of Raman spectroscopic analysis applied to DLC species;

FIG. 4. shows a principle of plasma chemical vapor deposition (P-CVD) process by which the coating layer and/or surface protection layer is formed according to the present invention;

FIG. 5 is a timing chart of application of plasma and pulse voltage in the plasma CVD process of FIG. 4;

FIG. 6 shows a transfer paddle for use with an embodiment of the invention;

FIG. 7 shows a cassette for use with an embodiment of the invention; and

FIG. 8 shows a susceptor or a wafer tray for use with an embodiment of the invention.

### DETAILED DESCRIPTION OF THE PREFERRED EMBODIMENT

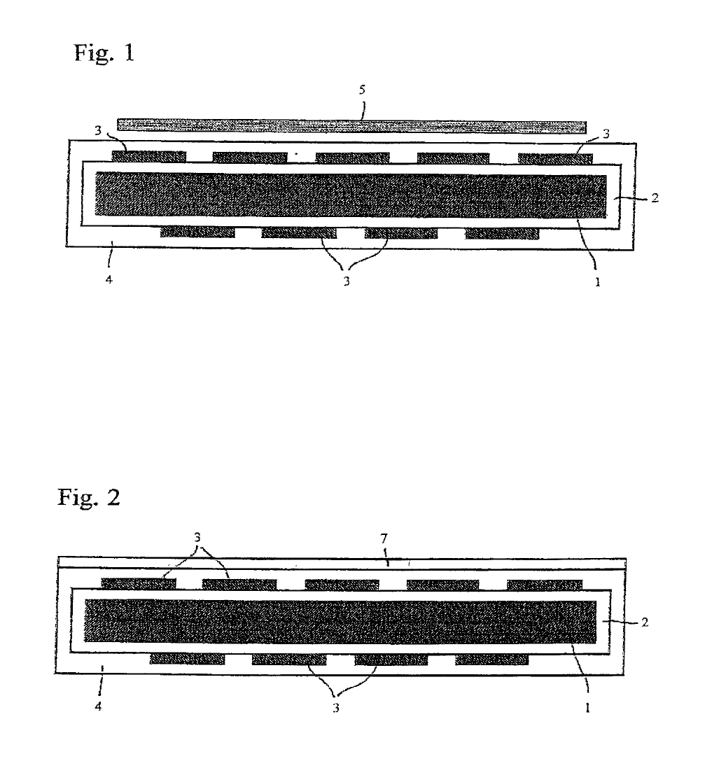

in one embodiment, shown in FIG. 1, a wafer handling device may include a graphite substrate 1, a PBN insulator 2 surrounding the graphite substrate 1, conductive electrodes 3 superimposed upon or imbedded within a PBN insulator 2 surrounding the graphite substrate 1 and conductive electrodes 3, an insulating separator or coating 4 surrounding the PBN insulator 2 and electrodes 3, and a power source of voltage (not shown) for applying a predetermined voltage between the opposite ends of the electrodes 3 so as to clamp a workpiece 5 to the handling surface of the handling device. In an embodiment of the present invention, the coating 4 may include DLC formed by a plasma chemical vapor deposition (P-CVD) process.

<EXAMPLE 1>

A 10 mm thick of graphite substrate was coated with 300 micrometers thick of a PBN film layer 2 by a chemical vapor deposition (CVD) process. 50 micrometer thick of a pyrolytic graphite (PG) was applied onto said PBN layer 2 also by a CVD process, which was then partly removed so that the remaining PG film layer forms predetermined patterns of conductive electrodes 3. Then, a coating layer 4 was deposited on the PBN layer 2 and electrodes 3 by a plasma CVD (P-CVD) process to produce a WHD (wafer handling device). In the P-CVD process in this example, pressure of the process system was reduced to 6×10⁻³-@Torr, a hydrogen gas (acetylene C₂ H₂ in this case) was introduced into the system and a pulse voltage of −5000 V was applied to both the electrodes 3 and graphite substrate 1 for P-CVD operation. The electric resistivity of the coating 4 was measured and found to be approximately 10 sup 8 and 10 sup 13/&−cm.

<Control 1>

For comparison, another WHD was manufactured in like manner as in manufacturing the wafer handling device of Example 1 except that the thickness of the DLC coating layer 4 was 2.0 micrometers.

<Control 2>

After preparing the substrate 1 with a PBN layer 2 and electrodes 3 on both surfaces thereof in like manner as in Example 1, a carbon-doped PBN coating layer 4 was formed to surround the PBN layer 2 and the electrodes 3 by a CVD process as taught by U. S. Pat. No. 5,606,484 to produce a WHD of Control 2. More specifically, the carbon-doped PBN coating layer 4 was formed by introducing a mixture gas consisting of boron trichloride (BCl₃), ammonia (NH₃ ) and methane (CH₄ ) at a mole ratio of 1:3:2.4 into a high vacuum thermal reaction chamber to cause a chemical reaction at a pressure of 0.5 Torr and at a temperature of 1850 degrees Celsius.

<Example 2>

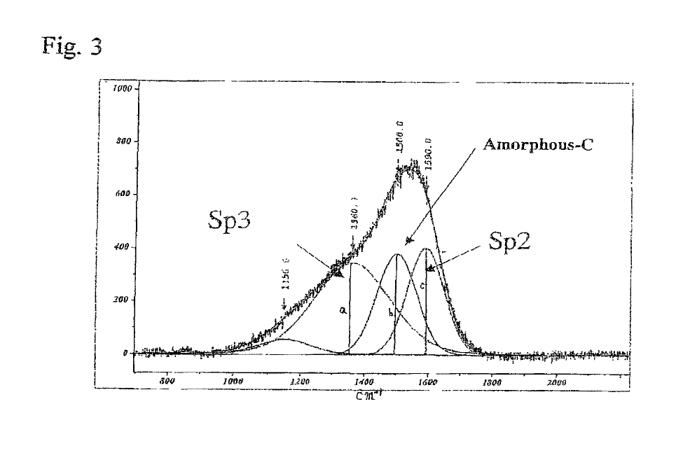

The WHD of Control 2 was then subjected to a P-CVD process wherein an acetylene (C₂ H₂ ) gas was reacted at a pulse voltage of −5000 V which was applied to the electrodes, and at a pressure of 6_{—}˜10 sup−3 Torr(6_{—}˜10⁻³ Torr) to deposit a DLC surface protection layer 7, as shown in FIG. 2. The electric resistivity of the DLC surface protection layer 7 was measured and found to be approximately 10 sup 8 and 10 sup 13/&−cm.

Voltages of 1000 V and 2000 V were applied to the wafer handling device of Examples 1,2 and Controls 1,2 for dielectric breakdown tests. The WHD of Control 1 showed dielectric breakdown at 1000 V voltage application to reduce its electric resistivity, by which the chucking force was reduced to below a practical level desired. The WHD of Example 1 showed no dielectric breakdown at 1000 V voltage application.

When a dielectric strength is supposed to be 400000 V/mm, the coating thickness which would not be dielectrically broken down by application of 1000V voltage is (1000_{—}˜1000)/400000=2.5 micrometers. Accordingly, the thickness of the DLC coating 4 is preferably at least 2.5 micrometers.

Meanwhile, the chucking force is determined by the following equation according to the Coulomb=s law:

F=(½)_E/Ã−_iV/d_j²

Wherein F represents chucking force (g/cm²), between a workpiece and a handling surface, /Ã a dielectric constant of the coating layer, d thickness (cm) of the coating layer and V a voltage applied.

The C-PBN coating layer must have a greater thickness. In fact, the C-PBN coating layer of the handling device of Control 2 has 150 micrometers thickness, as shown in Table IT, which is much thickerthan the DLC coating layer(of 2.5 micrometers thickness) of the WHD of Example 1. In order that the WHD of Control 2 provides a sufficient chucking force, a voltage to be applied should be increased to at least 2000 V, as known from the above-referred equation.

The handling device of Control 2 showed abrasive marks and approximately 1 micrometer sized particles were generated thereby on the C-PBN coating layer after 70000silicone wafers handling operation. The handling device of Example 2 wherein the C-PBN coating layer is further coated with a surface protection layer of DLC showed an improved wear-resistance property, which is durable to the same 70000 handling operation.

The construction of the WHD of Examples 1,2 and Controls 1,2 are shown in the following Table IT, as well as the results of dielectric breakdown tests and wear-resistance tests.

TABLE IT

| | Example 1 | Control 1 | Control 2 | Example 2 |
|---|---|---|---|---|
| Coating Layer | DLC 2.5/Ê | DLC 2.0/Ê | C-PBN 150/Ê | C-PBN 150/Ê |
| (Resistivity) | _i10¹⁰/&- | _i10¹⁰/&- | _i10¹⁰/&- | _i10¹⁰/&- |
| | cm_j | cm_j | cm_j | cm_j |
| Surface Protection | None | None | None | DLC 1.0/Ê |
| Layer | | | | _i10¹⁰/&- |
| (Resistivity) | | | | cm_j |
| Dielectric | No | Yes | No | No |
| Breakdown | | | | |
| 1000 V | | | | |
| 2000 V | | | | |
| Wear-Resistance | No Abrasive | | Abrasive | No Abrasive |
| | Marks | | Marks | Marks |
| | Occurred | | Occurred | Occurred |

Formation of the DLC coatings of the WHDs of Example 1 and Control 1 and formation of the DLC surface protection layer of the handling device of Example 2 were all carried out by a plasma CVD (P-CVD) process. In the P-CVD process, a hydrocarbon gas such as acetylene and benzene is introduced into a vacuum container and subjected to high energy by using energy sources such as direct-current (DC) discharge and radio frequency (RF) employing high voltage pulse to ionize the hydrocarbon gas, which are electrically accelerated and deposited on a product to form a DLC coating or layer thereon. This P-CVD process is suitable for use in formation of DLC coating or layer in the present invention, because the DLC coating or layer formed by the P-CVD process would inevitably contain a small amount of hydrogen, which facilitates that the DLC coating layer 4 or the DLC surface protection layer 7 has a preferable range of electric resistivity of 10 sup 8 and 10 sup 13/&−cm. Although another process, including a spattering process using a solid carbon source is also known as a process' for formation of a DLC coating or layer, the DLC coating or layer formed by such a process contains no hydrogen.

To prove a favorable range of hydrogen content in the DLC coating layer 4, various WHDs were manufactured by changing process variables of the P-CVD process in Example 1, and the electric resistivity and hydrogen content of the resulting DLC coating layer 4 ware measured, the results of which are shown in the following Table IU.

TABLE IU

| | | | | | | H |
|---|---|---|---|---|---|---|
| | | | Flow | | | content |
| | Pulse | | Rate | Pressure | Resisitivity | (atom |
| No. | (-KV) | Gas | (sccm) | (Torr) | (/&-cm) | %) |
| 1 | 10 | C₂H₂ | 6 | 6_˜10⁻³ | 3.3_˜10⁸ | 25 |
| 2 | 10 | C₂H₂ | 6 | 6_˜10⁻³ | 1.4_˜10⁹ | 21 |
| 3 | 10 | C₂H₂/H₂ | 6/2 | 6_˜10⁻³ | 1.9_˜10⁹ | 23 |
| 4 | 10 | C₂H₂/H₂ | 6/6 | 6_˜10⁻³ | 7.8_˜10⁸ | 24 |
| 5 | 10 | C₇H₈ | 6 | 6_˜10⁻³ | 1.7_˜10¹¹ | 21 |
| 6 | 10 | C₇H₈ | 6 | 6_˜10⁻³ | 5.0_˜10¹¹ | 21 |
| 7 | 10 | C₇H₈ | 6 | 9_˜10⁻³ | 1.7_˜10¹² | 18 |
| 8 | 10 | C₇H₈ | 9 | 6_˜10⁻³ | 1.3_˜10¹² | 17 |
| 9 | 10 | C₇H₈ | 9 | 9_˜10⁻³ | 3.3_˜10¹¹ | 17 |

The hydrogen content was measured by an ERD (elastic recoil detection)method wherein helium atoms (He) are accelerated and bombarded a specimen(that is the DLC coating layer 4 in this case) to count the number of hydrogen atoms (H) coming out of the specimen.

From the results shown in Table IU, it may be confirmed that the electric resistivity of the DCL coating layer 4 decreases substantially proportion with increase of the hydrogen content. It is also demonstrated that the DLC coating layer 4 should have the hydrogen content ranging from 15 to 26 atom % in order to have the electric resistivity ranging from 10 sup 8 and 10 sup 13/&−cm.

Further tests and experiments have revealed that there is a correlation between electric resistivity of DLC and a ratio of intensities at 1360 cm⁻¹ and at 1500 cm⁻¹ which is obtained by Raman spectroscopic analysis of carbon structure of DLC. Raman spectroscopic analysis is a known technique to analyze a structure of a substance by irradiating the substance with a predetermined laser beam so that atoms in the substance oscillates or rotates to produce scattered light or Raman spectrum, intensity of which is measured.

An example of the results of Raman spectroscopic analysis of DLC species is shown in an intensity chart of FIG. 3. As described before, DLC structure is a mixture of a graphite structure (SP2) and a diamond structure (SP 3 ) and, therefore, provides a hydrocarbon intensity peak at 1150 cm⁻and a irregular graphite intensity peak at 1360 cm⁻¹, an amorphous carbon intensity peak at 1500 cm⁻¹ and a regular graphite intensity peak at 1590 cm⁻¹ in its intensity chart of Raman spectroscopic analysis. The inventors have found that electric resistivity of DLC is greatly influenced by an intensity ratio of (b)/(a) ((a) is an irregular graphite intensity at 1360 cm⁻¹ and (b) is an amorphous carbon intensity at 1500 cm⁻¹).

Samples 1-16 of WHDs of the construction of FIG. 1 have been manufactured by changing process variables in the P-CVD process to form DLC coating layer 4 in Example 1, as shown in the following, Table IV._@ The measured electric resistivity and the intensity ratio (b)/(a), stated above, in Raman spectroscopic analysis of the DLC coating layer 4 of each sample are shown in Table IW.

TABLE IV

| | Pulse Voltage | | Flow Rate | Pressure |
|---|---|---|---|---|
| No. | (−kV) | Gas | (sccm) | (Torr) |
| 1 | 10 | C₂H₂ | 6 | 6_˜10⁻³ |
| 2 | 20 | C₂H₂ | 6 | 6_˜10⁻³ |
| 3 | 10 | C₂H₂ | 6 | 6_˜10⁻³ |
| 4 | 10 | C₂H₂/H₂ | 6/2 | 6_˜10⁻³ |
| 5 | 10 | C₂H₂/H₂ | 6/4 | 6_˜10⁻³ |
| 6 | 10 | C₂H₂/H₂ | 6/6 | 6_˜10⁻³ |
| 7 | 10 | C₂H₂/H₂ | 6/50 | 6_˜10⁻³ |
| 8 | 10 | C₇H₈ | 6 | 6_˜10⁻³ |
| 9 | 10 | C₇H₈/H₂ | 4/6 | 6_˜10⁻³ |
| 10 | 10 | C₇H₈ | 6 | 6_˜10⁻³ |
| 11 | 10 | C₇H₈ | 6 | 6_˜10⁻³ |
| 12 | 10 | C₇H₈ | 96 | 6_˜10⁻³ |
| 13 | 10 | C₇H₈ | 9 | 6_˜10⁻³ |
| 14 | 10 | C₇H₈ | 6 | 6_˜10⁻³ |
| 15 | 10 | C₇H₈ | 6 | 6_˜10⁻³ |
| 16 | 10 | C₇H₈ | 6 | 6_˜10⁻³ |

TABLE IW

| | | Results of Raman Spectrum Analyses | | |
|---|---|---|---|---|
| No. | Resistivity | Intensity at | Intensity at | Intensity Ratio |
| 1 | 3.3_˜10⁸ | 5.43_˜10² | 4.89_˜10² | 0.9006 |
| 2 | 1.0_˜10⁷ | 3.34_˜10² | 2.16_˜10² | 0.6467 |
| 3 | 1.4_˜10⁹ | 4.22_˜10² | 4.13_˜10² | 0.9787 |
| 4 | 1.9_˜10⁹ | 5.33_˜10² | 4.93_˜10² | 0.9250 |
| 5 | 2.5_˜10⁹ | 4.92_˜10² | 4.85_˜10² | 0.9858 |
| 6 | 7.8_˜10⁸ | 4.97_˜10² | 4.57_˜10² | 0.9195 |
| 7 | 5.3_˜10⁹ | 6.97_˜10² | 5.47_˜10² | 0.7848 |
| 8 | 1.7_˜10¹¹ | 4.22_˜10² | 4.41_˜10² | 1.0450 |
| 9 | 8.3_˜10¹⁰ | 3.66_˜10² | 3.90_˜10² | 1.0656 |
| 10 | 5.0_˜10¹¹ | 3.71_˜10² | 3.85_˜10² | 1.0369 |
| 11 | 1.7_˜10¹² | 3.34_˜10² | 3.44_˜10² | 1.0313 |
| 12 | 1.3_˜10¹² | 3.47_˜10² | 3.81_˜10² | 1.0967 |
| 13 | 3.3_˜10¹¹ | 3.77_˜10² | 4.14_˜10² | 1.0982 |
| 14 | 9.6_˜10¹⁰ | 3.30_˜10² | 3.51_˜10² | 1.0626 |
| 15 | 1.0_˜10¹² | 3.57_˜10² | 3.98_˜10² | 1.1158 |
| 16 | 1.3_˜10¹¹ | 2.94_˜10² | 2.92_˜10² | 0.9932 |

As shown, it has been known that there is a correlation such that the electric resistivity of DLC coating layer 4 increases substantially in proportion to the intensity ratio (b)/(a) in Raman spectroscopic analysis. More specifically, it has been confirmed that DLC coating layer 4 should have the intensity ratio (b)/(a) in Raman spectroscopic analysis of 0.7 B 1.2 in order to provide the electric resistivity ranging from 10 sup 8 and 10 sup 13/&−cm.

<Experiments 1>

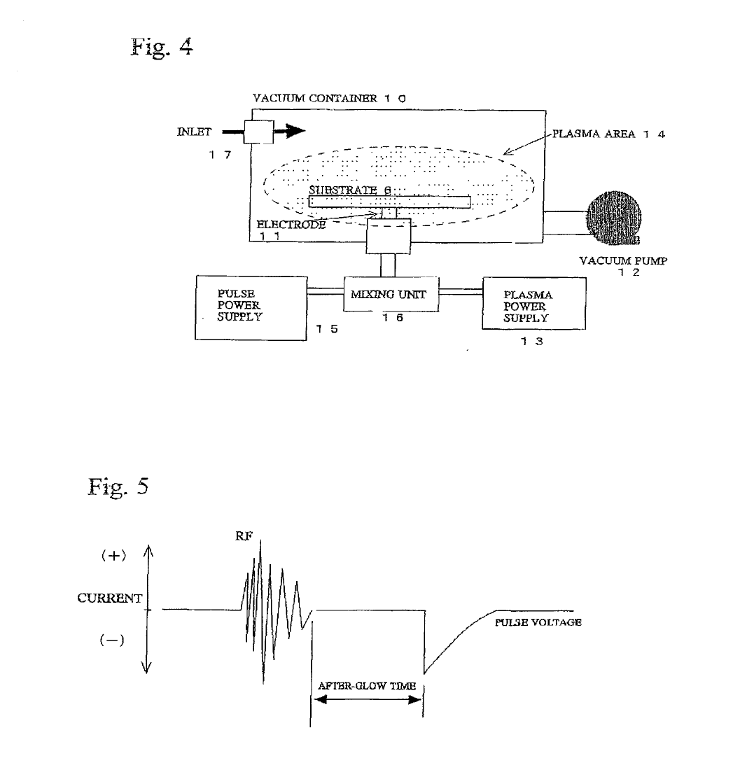

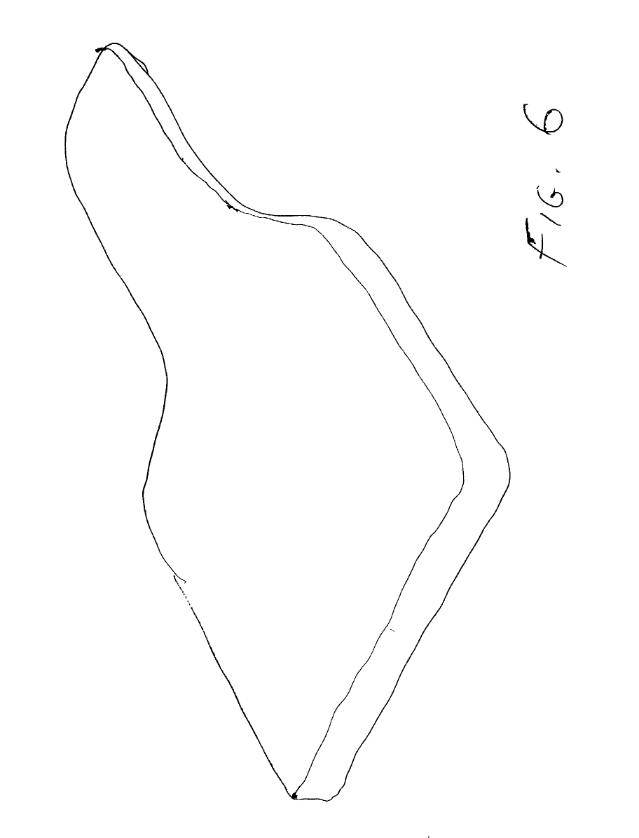

After preparing the intermediate having the graphite compact 1, PBN insulating layer 2 and the electrodes 3 on both surfaces thereof in like manner as in Example 1, coating layers 4 were formed to surround the PBN film layer 2 and the electrodes 3 by a P-CVD process to produce a WHD wherein various hydrocarbon compounds were used as a plasma source in the P-CVD process. Referring specifically to FIG. 3 and FIG. 4, in a P-CVD process, a substrate 6 (on which a DLC coating layer 4 should be deposited) may be placed on an electrode 11 in a vacuum container 10, which may be maintained in a reduced internal pressure condition by a vacuum pump 12, and a hydrocarbon compound (CxHy) in gaseous, liquid or solid condition may be introduced into the container 10 through an inlet 17. A radio frequency (RF) voltage may be applied from a plasma power source 13 via a mixing unit 16 to the substrate 6 to form a plasma area 14 therearound, which facilitates ionization of the introduced hydrocarbon. After a predetermined after-glow time (which means a period of time after application of a plasma RF voltage may be completed and before application of a pulse voltage commences), a predetermined pulse voltage supplied from a pulse power source 15 may be applied via the mixing unit 16 to the substrate 6, so that the ionized hydrocarbon may be electrically accelerated and deposited upon the surface of the substrate as DLC coating layer 4. In the experiments, the internal pressure of the vacuum container 10 was controlled to be 6 B 9 _{—}˜10⁻³ Torr and the gas flow rate was seen. The electric resistivity of the DLC coating layers 4 of the resulting WHDs were measured, the results of which are shown in the following Table V.

TABLE IX

| | Methane | Acetylene | toluene | xylene | decane |
|---|---|---|---|---|---|
| | (CH₄) | (C₂H₄) | (C₇H₈) | (C₈H₁₀) | (C₁₀H₂₂) |
| Resistivity | 1.5_˜10⁸ | 1.4_˜10⁹ | 1.3_˜10¹¹ | 5.3_˜10¹² | 1.7_˜10¹³ |
| (/& Bcm) | | | | | |
| Intensity | 0.8747 | 0.9787 | 1.0625 | 1.1202 | 1.1751 |
| Ratio | | | | | |

As shown in Table V, the electric resistivity of DLC coating layers 4 were all within favorable range, that may be from 10 sup 8 and 10 sup 13/&−cm. The results also suggest that the electric resistivity of DLC coating layer formed by P-CVD process correlates with molecular weight of hydrocarbon compound introduced to the vacuum container 10. In addition, the electric resistivity of DLC coating layer which was formed by methane (CH₄) having the smallest molecular weight among the hydrocarbon compounds used in the experiments was almost approximate to the lower limit of the favorable range, whereas the electric resistivity of DLC coating layer formed by decane (C₁₀H₂₂) having the largest molecular weight was almost approximate to the upper limit of the favorable range. From these results, it has been found that a hydrocarbon compound (CxHy) of which (x) ranges 1-10 and (y) ranges 2-22 should be used in the P-CVD process in order to form DLC coating layer 4 having electric resistivity within the favorable range, that may be from 10 sup 8 and 10 sup 13/&−cm.

Table V also shows the intensity ratio (b)/(a), stated above, in Raman spectroscopic analysis of DLC coating layers 4 of the resulting WHDs. As described before, there is a correlation between electric resistivity of DLC coating layer and the DLC coating should have the intensity ratio (b)/(a) wherein (a) is an irregular graphite intensity peak at 1360 cm⁻¹ and (b) is an amorphous carbon intensity peak at 1500 cm⁻¹ in Raman spectroscopic analysis, and it has been confirmed that the intensity ratio (b)/(a) should be 0.7 B 1.2 in order to form a favorable DLC coating layer having the electric resistivity ranging from 10 sup 8 and 10 sup 13/&−cm. As shown in Table V, each of DLC coating layers 4 of the resulting WHDs has the intensity ratio (b)/(a) of 0.7 B 1.2.

<Experiments 2>

Various WHDs were manufactured in like manner as in Experiments 1 except that toluene (C₇ H₈) was introduced into the vacuum container 10 and the pulse voltage to be applied was varied within a range from −1 kV to −20 kV in the P-CVD process for deposition of DLC coating layers. The electric resistivity of the DLC coating layers 4 of the resulting WHDs were measured, the results of which are shown in the following Table IY.

TABLE IY

| | | | | | | |
|---|---|---|---|---|---|---|
| Pulse Voltage | −1.0 kV | −2.0 kV | −5.0 kV | −10.0 kV | −15.0 kV | −20.0 kV |
| Resistivity | 1.1_˜10¹³ | 6.7_˜10¹² | 1.0_˜10¹² | 6.7_˜10¹⁰ | 3.0_˜10⁸ | 9.5_˜10⁷ |
| (/&-cm) | | | | | | |

As shown in Table IY, the electric resistivity of DLC coating layers 4 were all within favorable range, that may be from 10 sup 8 and 10 sup 13/&−cm. The results also suggest that the electric resistivity of DLC coating layer formed by P-CVD process correlates with the pulse voltage applied from the power source 15 in the P-CVD process. Further, the electric resistivity of DLC coating layer which was formed when the pulse voltage used in the P-CVD process may be the smallest one, that may be −1.0 kV, was almost approximate to the upper limit of the favorable range, whereas the electric resistivity of DLC coating layer formed when the pulse voltage may be the largest, that is −20.0 kV was almost approximate to the lower limit of the favorable range. From these results, it has been found that the pulse voltage ranging from −1.0 kV to −20.0 kV should be applied in the P-CVD process in order to form DLC coating layer 4 having electric resistivity within the favourable range, that may be from 10 sup 8 and 10 sup 13/&−cm.

<Experiments 3>

The P-CVD process was carried out to form DLC coating layer 4 in like manner as in Experiments 1 except that the pulse voltage applied was −5 kV and the after-glow time was varied within a range of 70 B 250 microseconds. The electric resistivity of the DLC coating layers 4 of the resulting WHDs were measured, the results of which are shown in the following Table IZ.

TABLE IZ

| After-Glow Time | | | | |
|---|---|---|---|---|
| (/Êsec.) | 70 | 110 | 150 | 250 |
| Resistivity | 1.4_˜10¹¹ | 3.0_˜10¹² | 4.3_˜10¹² | 2.2_˜10¹³ |
| (/&-cm) | | | | |

As shown in Table IZ, the electric resistivity of DLC coating layers 4 were all within favorable range, that may be from 10 sup 8 and 10 sup 13/&−cm. The results also suggest that the electric resistivity of DLC coating layer formed by P-CVD process correlates with the pulse voltage applied from the power source 15 in the P-CVD process. Further, the electric resistivity of DLC coating layer formed with the longest after-glow time, that may be 250 microseconds, was almost approximate to the upper limit of the favorable range. Accordingly, the after-glow time of smaller than 250 microseconds should be applied in the P-CVD process in order to form DLC coating layer 4 having electric resistivity within the favorable range, that may be from 10 sup 8 and 10 sup 13/&−cm.

<Experiments 4>

When a WHD having the construction of FIG. 2 was formed in like manner as in Example 2, a DLC surface protection layers 7 were formed by a P-CVD process wherein a hydrocarbon compound to be used as a plasma source was variously changed in the same manner as in Experiments 1, the pulse voltage to be applied was varied in the same manner as in Experiments 2 and the after-glow time was varied in the same manner as in Experiments 3. The results were substantially the same as described before in conjunctions with Experiments 1B3. More specifically, in order that DLC layer 7 having electric resistivity within the favorable range, that may be from 10 sup 8 and 10 sup 13/&−cm may be formed by a P-CVD process, the P-CVD process should be carried out by employing hydrocarbon compound (CxHy) of which (x) ranges 1B10 and (y) ranges 2B22 and applying the pulse voltage ranging from −1.0 kV to −20.0 kV with the after-glow time of smaller than 250 microseconds.

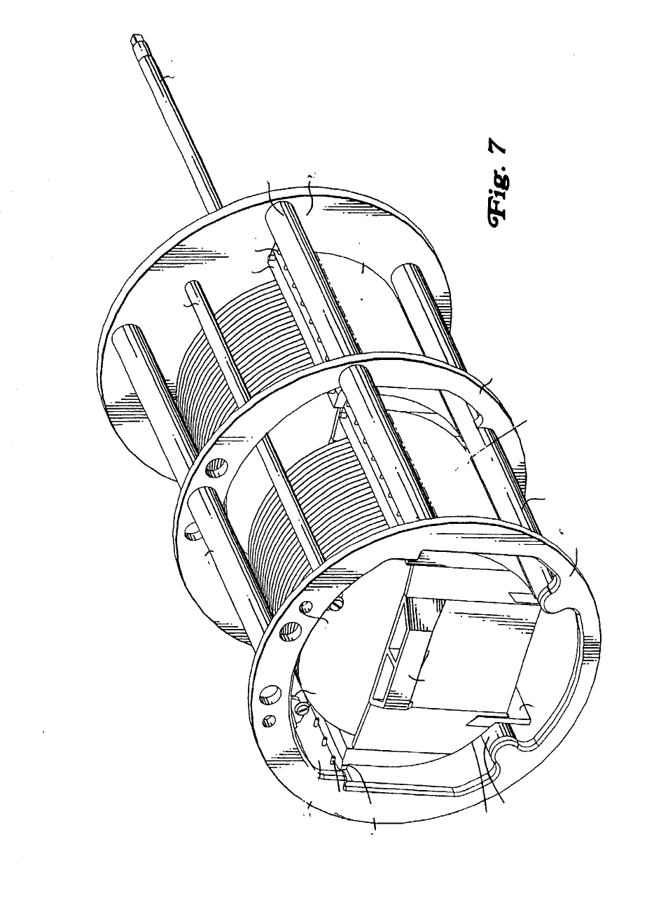

A wafer handling device may be, e.g. a transfer paddle, as shown in FIG. 6. Wafers may be moved between various steps in a wafer fabrication process on transfer paddles. The transfer paddles are often metal, plastic, or ceramic, and may have vacuum chucking or electrostatic chucking capability, or locating knobs. All of the surfaces of the transfer paddles that are in contact with the wafer could generate particles deleterious to the process, such as, for example, due to friction caused by expansion and contraction of the wafer due to heating and cooling. Coating transfer paddles with DLC, a hard and wear resistant coating with a low coefficient of friction, could mitigate particle generation and improve yield.

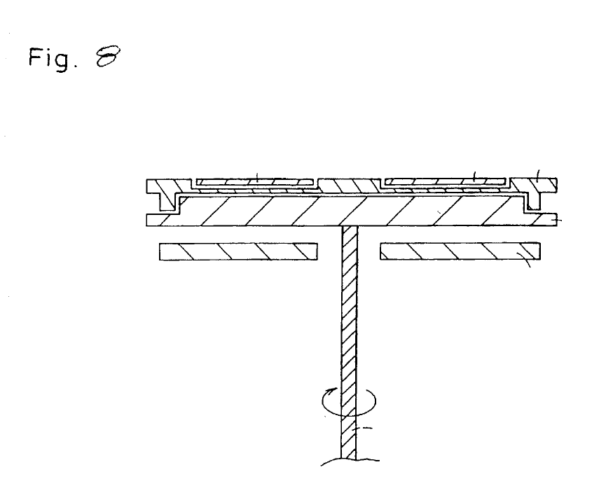

A wafer handling device may be, e.g. a cassette, as shown in FIG. 7. Wafers may be transferred between different tools on cassettes. A cassette is a stack of shelves holding just the outer edge or just a portion of each individual wafer. Space is allowed vertically between each wafer to enable, e.g. a transfer paddle to pick up a wafer and load it into a specific process step. The surfaces of the cassettes can wear on the wafer and generate particles. Coating the cassette contact surfaces with DLC can mitigate particle generation and improve yield. Cassettes are usually made of plastic, but also may be made of metal or quartz.

A wafer handling device may be, e.g. a susceptor or a wafer tray, as shown in FIG. 8. A wafer may be set in a tray during processing, such as for etching or for photolithography. These trays may be heated. Wear between the wafer and the tray may cause particle generation. Coating the tray contact surfaces with DLC can mitigate particle generation and improve yield.

Although components like transfer paddles, platters, and cassettes are typically made of graphite, the base material may also be alumina, silicon carbide, or other ceramics. All of these particulate ceramic base materials are likely to shed particles during semiconductor manufacturing operations, so they are all typically coated with something hard and impervious. Graphite is frequently coated by Chemical Vapor Deposition (CVD) with silicon carbide or ‘pyrolytic’, i.e. CVD graphite; alumina can be coated with various glasses or with CVD aluminum nitride. The diamond-like coating (DLC) of the present invention is a particularly good coating for non-oxide base materials such as graphite and boron nitride. It is a particularly good as a top coating over pyrolytic boron nitride. Although DLC can be used effectively to coat paddles, platters and cassettes that are used to process wafers, its affinity for graphite and boron nitride makes it an especially suitable coating for passive components used to transport wafers of III-V compounds such as GaAs and InP.

Although the present invention has been described in conjunction with specific embodiments thereof, it is to be understood that the present invention is not limited to these embodiments and many modifications and variations may be made without departing from the scope and the spirit of the present invention as specifically defined in the appended claims. For example, though the WHD in the foregoing examples, controls and experiments may include graphite substrate 1 surrounded by a PBN insulator 2 (FIG. 1 and FIG. 2), it may comprise solely an insulating substrate of ceramic material such as oxides and nitrides. The conductive electrodes may be molybdenum (Mo), tantalum (Ta), tungsten (W) or any other metals having a high-melting point.

What is claimed is:

1. An apparatus for supporting a workpiece during processing comprising a wafer handling device, a coating layer surrounding said wafer handling device, said coating layer consisting essentially of non-crystal line carbon and having electric resistivity ranging from 10 sup 8 and 10 sup 13/&−cm.

2. The apparatus according to claim 1 wherein said coating layer has thickness of at least 2.5 micrometers.

3. The apparatus according to claim 1 wherein said workpiece is a wafer.

4. The apparatus according to claim 1 wherein said wafer handling device is selected from the group consisting of:
an electrostatic chuck;
a heater;
a transfer paddle,
a cassette,
a susceptor, and
a wafer tray.

5. The apparatus according to claim 1 wherein said coating layer is formed by a plasma chemical vapor deposition process.

6. The apparatus according to claim 1 wherein said coating layer contains 15-26 atom % of hydrogen.

7. An apparatus for supporting a workpiece during processing comprising a wafer handling device, a coating layer surrounding said wafer handling device, a surface protection layer formed on at least one surface of said coating layer and consisting essentially of non-crystalline carbon and having electric resistivity ranging from 10 sup 8 and 10 sup 13/&−cm.

8. The apparatus according to claim 7 wherein said surface protection layer contains 15-26 atom % of hydrogen.

9. An apparatus for supporting a workpiece during processing comprising a wafer handling device, a coating layer surrounding said wafer handling device, said coating layer consisting essentially of non-crystalline carbon and having electric resistivity ranging from 10 sup 8 and 10 sup 13/&−cm, said coating layer having an intensity ratio of 0.7 B 1.2, said intensity ratio being defined as a ratio of an intensity at 1360 cm⁻¹ to another intensity at 1500 cm⁻¹ when said coating layer is subjected to Raman spectroscopic analysis.

10. The apparatus according to claim 9 wherein said coating layer has thickness of at least 2.5 micrometers.

11. The apparatus according to claim 9 wherein said coating layer comprising non-crystalline carbon is formed by a plasma chemical vapor deposition process.

12. The apparatus according to claim 9 wherein said coating layer contains 15-26 atom % of hydrogen.

13. An apparatus for supporting a workpiece during processing comprising a wafer handling device, a coating layer surrounding said wafer handling device, a surface protection layer formed on at least one surface of said coating layer and consisting essentially of non-crystalline carbon and having electric resistivity ranging from 10 sup 8 and 10 sup 13/&−cm, said surface protection layer having an intensity ratio of 0.7 B 1.2, said intensity ratio being defined as a ratio of an intensity at 1360 cm⁻¹ to another intensity at 1500 cm⁻¹ when said coating layer is subjected to Raman spectroscopic analysis.

14. The apparatus according to claim 13 wherein said surface protection layer contains 15-26 atom % of hydrogen.

15. A method of manufacturing a wafer handling device for supporting a workpiece comprising the steps of:
subjecting a wafer handling device to a plasma chemical vapor deposition process wherein hydrocarbon (CxHy) of which (x) ranges 1 B10 and (y) ranges 2 B 22 is introduced into a vacuum container and ionized therein by ionizing (plasma) process and ionized hydrocarbon is deposited on the surface of said wafer handling device by applying thereto a predetermined pulse voltage, so that said wafer handling device is coated with a coating layer consisting essentially of non-crystalline carbon and having electric resistivity ranging from 10 sup 8 and 10 sup 13/&−cm.

16. A method of manufacturing a wafer handling device for supporting a workpiece comprising the steps of:
subjecting a wafer handling device to a plasma chemical vapor deposition process wherein hydrocarbon (CxHy) is introduced into a vacuum container and ionized therein by ionizing process and ionized hydrocarbon is deposited on the surface of said wafer handling device by applying thereto a pulse voltage ranging from −1 kV to −20 kV, so that said wafer handling device is coated with a coating layer consisting essentially of non- crystalline carbon and having electric resistivity ranging from 10 sup 8 to 10 sup 13/ &- cm.

17. A method of manufacturing a wafer handling device for supporting a workpiece comprising the steps of:
subjecting a wafer handling device to a plasma chemical vapor deposition process wherein hydrocarbon (CxHy) is introduced into a vacuum container and ionized therein by ionizing process and ionized hydrocarbon is deposited on the surface of said wafer handling device by applying thereto a predetermined pulse voltage within an after-glow time of smaller than 250 microseconds, so that said wafer handling device is coated with a coating layer consisting essentially of non-crystalline carbon and having electric resistivity ranging from 10 sup 8 and 10 sup 13/&−cm.

18. A method of manufacturing a wafer handling device for supporting a workpiece comprising the steps of:
subjecting a wafer handling device to a plasma chemical vapor deposition process wherein hydrocarbon (CxHy) of which (x) ranges 1-10 and (y) ranges 2-22 is introduced into a vacuum container and ionized therein by ionizing process and ionized hydrocarbon is deposited on the surface of said wafer handling device by applying thereto a pulse voltage ranging from −1 kV to −20 kV within an after-glow time of smaller than 250 microseconds, so that said wafer handling device is coated with a coating layer consisting essentially of non-crystalline carbon and having electric resistivity ranging from 10 sup 8 and 10 sup 13/&−cm.

19. A method of manufacturing a wafer handling device for supporting a workpiece comprising the steps of:
coating said wafer handling device with a coating layer; and
subjecting said coating layer to a plasma chemical vapor deposition process wherein hydrocarbon (CxHy) of which (x) ranges 1-10 and (y) ranges 2-22 is introduced into a vacuum container and ionized therein by ionizing process and ionized hydrocarbon is deposited on the surface of said coating layer by applying thereto a predetermined pulse voltage, so that said coating layer is coated with a surface protection layer consisting essentially of non-crystalline carbon and having electric resistivity ranging from 10 sup 8 and 10 sup 13/&−cm.

20. A method of manufacturing a wafer handling device for supporting a workpiece comprising the steps of:
coating said wafer handling device with a coating layer; and
subjecting said coating layer to a plasma chemical vapor deposition process wherein hydrocarbon (CxHy) is introduced into a vacuum container and ionized therein by ionizing process and ionized hydrocarbon is deposited on the surface of said coating layer by applying thereto a pulse voltage ranging form −1 kV to −20 kV, so that said coating layer is coated with a surface protection layer consisting essentially of non-crystalline carbon and having electric resistivity ranging from 10 sup 8 and 10 sup 13/&−cm.

21. A method of manufacturing a wafer handling device for supporting a workpiece comprising the steps of:
coating said wafer handling device with a coating layer; and
subjecting said coating layer to a plasma chemical vapor deposition process wherein hydrocarbon (CxHy) is introduced into a vacuum container and ionized therein by ionizing process and ionized hydrocarbon is deposited on the surface of said coating layer by applying thereto a predetermined pulse voltage within an after-glow time of smaller than 250 microseconds, so that said coating layer is coated with a surface protection layer essentially of non-crystalline carbon and having electric resistivity ranging from 10 sup 8 and 10 sup 13/&−cm.

22. A method of manufacturing a wafer handling device for supporting a workpiece comprising the steps of:
forming a wafer handling device on a wafer handling device;
subjecting said coating layer to a plasma chemical vapor deposition process wherein hydrocarbon (CxHy) of which (x) ranges 1-10 and (y) ranges 2-22 is introduced into a vacuum container and ionized therein by an ionizing process and ionized hydrocarbon is deposited on the surface of said coating layer by applying thereto a pulse voltage ranging from −1 kV to −20 kV within an after-glow time of smaller than 250 microseconds, so that said coating layer is coated with a surface protection layer consisting essentially of non-crystalline carbon and having electric resistivity ranging from 10 sup 8 and 10 sup 13/&−cm.
